(19) United States
(12) Patent Application Publication
(10) Pub. No.: US 2018/0188799 A1
(43) Pub. Date: Jul. 5, 2018

(54) COMPUTING SYSTEM CHARGING

(71) Applicant: INTEL CORPORATION, Santa Clara, CA (US)

(72) Inventors: Chee Lim Nge, Hillsboro, OR (US); Alexander B. Uan-Zo-Li, Hillsboro, OR (US); Philip R. Lehwalder, Hillsboro, OR (US); Jenn Chuan Cheng, Bayan Lepas FTZ (MY); Jeffrey A. Carlson, Portland, OR (US)

(73) Assignee: INTEL CORPORATION, Santa Clara, CA (US)

(21) Appl. No.: 15/396,549

(22) Filed: Dec. 31, 2016

(51) Int. Cl. G06F 1/32; H02J 7/00; G06F 1/26; G06F 13/38

(52) U.S. Cl. CPC G06F 1/3296; H02J 7/0081; G06F 13/385; G06F 1/3287; G06F 1/266

(57) ABSTRACT

In some examples, a charging system includes a battery and a power device. The power device is to be coupled in series with the battery in a manner that the power device is not in a system load path. The power device is to operate as a linear voltage regulator to control charging power.

### TECHNICAL FIELD

This disclosure relates generally to charging computing systems.

### BACKGROUND

The mobile computing industry is moving toward smaller and smaller form factors. Additionally, the central processing unit (CPU) can consume a lot of power in mobile systems, making thermal cooling more complex.

### BRIEF DESCRIPTION OF THE DRAWINGS

The following detailed description may be better understood by referencing the accompanying drawings, which contain specific examples of numerous features of the disclosed subject matter.

FIG. 1 illustrates a charging system;

FIG. 2 illustrates a charging system;

FIG. 3 illustrates a charging system;

FIG. 4 illustrates a computing system;

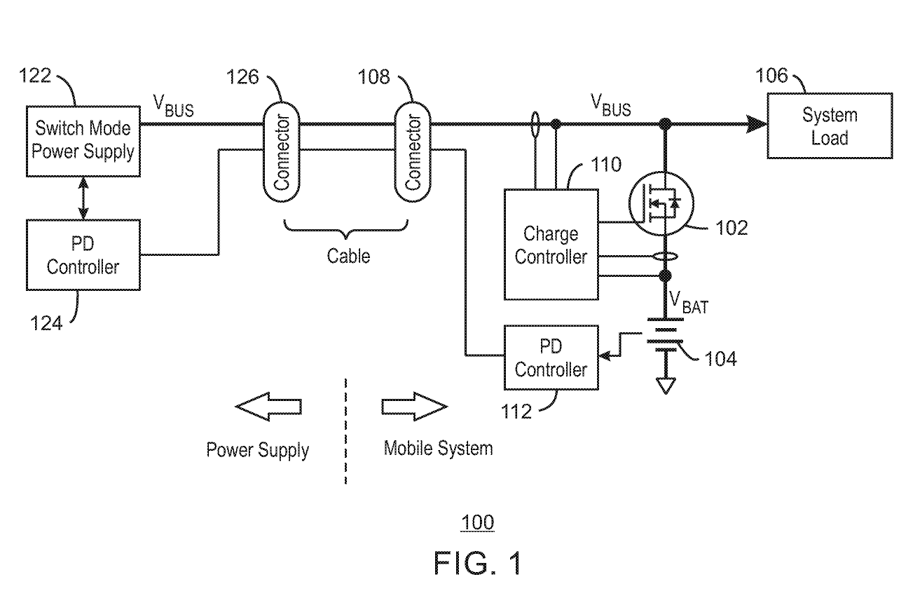

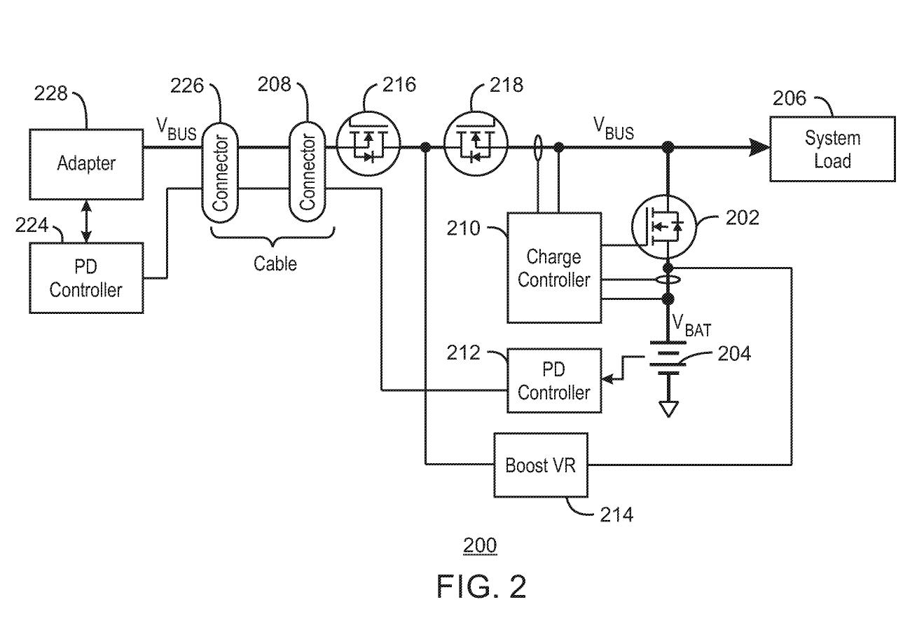

In some cases, the same numbers are used throughout the disclosure and the figures to reference like components and features. In some cases, numbers in the 100 series refer to features originally found in FIG. 1; numbers in the 200 series refer to features originally found in FIG. 2; and so on.

### DESCRIPTION OF THE EMBODIMENTS

Some embodiments relate to charging computing systems. Some embodiments relate to charging mobile systems.

As discussed above, the mobile computing industry is moving toward smaller and smaller form factors. Additionally, the central processing unit (CPU) can consume a lot of power in mobile systems, making thermal cooling more complex.

The computing industry is also moving toward using a Universal Serial Bus C connector (USB-C connector). The USB-C connector can allow variable system voltage using USB power delivery (USB PD) messaging.

In some embodiments, power loss of the charger in a mobile system can be reduced. In some embodiments, power loss of the charger in a mobile system can be reduced, while simultaneously reducing the size of the system. This can provide mobile systems with smaller form factors. It can also provide better performance when connected to an alternating current (AC) source.

One way to charge a computing system using USB-C power delivery (PD) is by using a buck-boost NVDC (narrow-voltage direct current) charging system. Such a buck-boost charger can include four metal oxide semiconductor field effect transistors (MOSFETs) in order to allow operation of the system over a wide range of input voltages. However, use of such a system can require all power from the adapter to go through the charger. Even when the battery is fully charged, power dissipation can occur in the charger. Additionally, such a charger can be inefficient since one leg may be in a pass-through mode when another leg is either in a boost or a buck mode. Further, a buck-boost NVDC charger can be large in area and costly. Charger power conversion losses can also limit performance of the CPU in small-form factor designs.

In a mobile system with USB-C PD as an input power source, a buck-boost NVDC charger is a switching regulator, which can be bulky since it may use four power devices. An NVDC system conducts the full system and battery charging power. However, in some embodiments, a V_{BUS} voltage can be modified to an appropriate voltage level and instead of a bulky switching charger, a small and simple linear voltage regulator (LVR) can be used.

FIG. 1 illustrates a charging system 100 to charge a mobile system. In some embodiments, charging system 100 includes a power supply (for example, a source) and a mobile system (for example, a sink). The mobile system can include a power device 102, a battery 104, a system load 106, a connector 108 (for example, a Universal Serial Bus Type-C connector), a charge controller 110 (for example, a battery charge controller) and a power delivery (PD) controller 112. The power supply can include a switch mode power supply 122, a power delivery (PD) controller 124, and a connector 126 (for example, a Universal Serial Bus Type-C connector).

A power stage of the charging system 100 includes the power device 102 in series with the battery 104. In some embodiments, the power device 102 can be a Metal Oxide Semiconductor Field Effect Transistor (MOSFET) power device. In some embodiments, the power device 102 can be a linear voltage regulator (LVR). It is noted that embodiments are not limited to the particular MOSFET device illustrated in the drawings of FIG. 1, and that different embodiments can include a different power device 102 than that specifically illustrated in the drawings. The V_{BUS} signal in FIG. 1 can directly supply a system load 106. The power device 102 is not in the path between the connector 108 (for example, USB Type-C connector) and the system load 106, which can reduce power loss.

In some embodiments, power device 102 in FIG. 1 can operate as a linear voltage regulator (LVR) to control the charging power. The V_{BUS} voltage level (for example, a USB-C PD V_{BUS} voltage level) can be dynamically adjusted to maintain a delta between the V_{BUS} voltage and the VBAT voltage in a range of 50 mV (millivolts) and 150 mV, for example, between an input and an output of the linear voltage regulator (LVR) through USB-C PD messaging. In some embodiments, the message interval can be in a range of hundreds of milliseconds (ms).

In an ideal system, the V_{BUS} voltage would stay at a constant level at or near the V_{BAT} battery voltage level. However, the system may change very quickly, with the V_{BUS} voltage going up or down due to impedance. At some point, IR losses occur, so the voltage may need to be raised in order to charge the battery 104. In some embodiments, the voltage may need to be lowered because the voltage is too high based on what the battery 104 needs. That is, there can be situations where the load is too high or too low, and the voltage needs to be adjusted. The power device 102 (for example, a linear regulator) can be used in some embodiments to help adjust the voltage accordingly.

Therefore, in some embodiments, the voltage is adjusted from the source (power supply) to the sink (system) to be as close as possible to a voltage requirement. In some embodiments, the voltage (for example, V_{BUS} voltage) that passes from a source (such as a power supply, for example) to a sink (such as a mobile system, for example) can be adjusted at the sink side (for example, mobile system side) to be as close as possible to a system load voltage requirement. A required voltage difference between the V_{BUS} voltage and the battery charging voltage V_{BAT} can be regulated in some embodiments by a linear regulator (for example, power device 102). In some embodiments, the V_{BUS} voltage is slowly adjusted (for example, through a slow path such as a path including power delivery controller 112). In some embodiments, the battery voltage (for example, V_{BAT}) is adjusted more quickly. For example, the battery voltage can be regulated at the right voltage instantaneously through a linear regulator (for example, power device 102). In some embodiments, this can reduce power loss.

In some embodiments, a circuit within the system can make sure that the V_{BUS} voltage operates as close as possible to the V_{BAT} voltage (that is, the voltage required to charge the battery). In some embodiments, the V_{BUS} voltage can be slowly adjusted to be as close as possible to the V_{BAT} voltage. This can be accomplished, for example, by the power delivery controller 112. In some embodiments, this can be accomplished by communication between the power delivery controller 124 on the source side (power supply side) and the power delivery controller 112 on the sink side (the system side). This communication can be implemented by the coupling between the power delivery controller 112 and the power delivery controller 124 through the connectors 108 and 126. In some embodiments, there is still a voltage difference between the V_{BUS} voltage and the V_{BAT} voltage (for example, due to relatively slow communication between the power delivery controllers 112 and 124). Therefore, in some embodiments, in order to make sure that the V_{BAT} voltage is maintained at the right level, voltage is regulated using the power device 102 (for example, a linear regulator), which can be a faster control path than the path between the power delivery controllers 112 and 124.

The charge controller 110 (for example, a battery charge controller) shown in FIG. 1 has a V_{BUS} voltage feedback loop to monitor the V_{BUS} voltage. The V_{BUS} voltage can droop, and the power supply can operate as a constant current source when the mobile system draws current exceeding the maximum current rating of the power supply. When the V_{BUS} voltage drops below the battery voltage, the charge controller 110 can fully turn on the power device 102 (for example, fully turn on the MOSFET in the linear voltage regulator) to allow voltage flow in an opposite direction, and the battery 104 can discharge.

The charger can operate in a hybrid mode when V_{BUS} drops below the battery voltage V_{BAT}. In the hybrid mode, both the power supply and the battery 104 are supplying power to the system load 106. The V_{BUS} voltage can clamp to the battery voltage V_{BAT} in this mode.

In some embodiments, when the system load (for example, system load 106) draws more power than what the power supply can deliver (for example, more than the switch mode power supply 122 can deliver), the VBUS voltage will being to drop quickly, and the VBUS voltage can become clamped to the VBAT voltage. The VBUS voltage can be clamped to the VBAT voltage, for example, in an embodiment in which power device 102 includes, for example, a MOSFET that is forward biased, and can clamp the voltage VBUS to the VBAT voltage. In this situation, the battery 104 can discharge and supplement the system load 106. In this embodiment, the system load 106 can draw more power than the switch mode power supply 122 can deliver. In some embodiments, power device 102 and/or charge controller 110 can help to discharge the battery voltage in order to enable the system load 106 to use the VBAT voltage to help the system load 106 use the battery voltage VBAT to draw more power than the power supply can handle. In some embodiments, a device such as charge controller 110 or some other device can be arranged in parallel with power device 102 to instantaneously begin to discharge the battery 104 in order to provide more power to the system load upon a drop of the VBUS voltage. In some embodiments, once the VBUS voltage drops, the battery voltage VBAT can be instantaneously used to power the system load.

In some embodiments, the system 100 of FIG. 1 can be useful in mobile systems in which a CPU of the mobile system is in a turbo mode.

In some embodiments, the charger illustrated in FIG. 1 is a pass FET (field effect transistor), and can be used as a linear voltage regulator (LVR). In FIG. 1, the charger is not in a series path between the USB-C connector and the series load, and the power supply V_{BUS} is connected directly to the system.

In some embodiments, the output voltage of the power supply can be controlled by the charger using USB-C PD messaging. The output voltage of the power supply need not track the battery voltage closely in time, and existing USB-C PD messaging using slow communication can be utilized.

In some embodiments, the output voltage of the power supply can loosely track the battery voltage (although it may be somewhat higher). In some embodiments, the charger illustrated in FIG. 1 is a linear regulator that is responsible for charging the battery. In some embodiments, the power supply is to maintain a 50 mV to 150 mV delta between the power supply V_{BUS} voltage and the battery voltage V_{BAT}. This can provide high charger efficiency, and sufficient voltage to allow the charger to charge the battery at a pre-determined charging current and voltage.

In some embodiments, the linear charger can have four control loops. In a constant current or constant voltage mode of charging, the charger monitors battery voltage and current, and maintains required battery charging current and/or voltage. One of the loops can monitor the adapter current, and can modify the charging current if the adapter current is going above the USB Type-C limit.

In some embodiments, one of the control loops of the linear charger is a voltage loop of the power supply voltage. If the system (for example, the mobile system in FIG. 1) consumes more power than the power supply can provide, then the power supply output voltage may start drooping. In order to achieve this in a controlled fashion, the power supply itself can be designed with a voltage droop capability. When the charger loop monitoring the power supply voltage detects that the V_{BUS} voltage is below the battery voltage, the charger can turn the linear voltage regulator MOSFET on completely so that it can start conducting in the opposite direction. This can occur without the charger boosting the voltage.

For example, in some embodiments, if the mobile system tries to draw current beyond a point where V_{BUS} drops to V_{BAT}, the V_{BUS} voltage can be clamped to the V_{BAT} voltage, because the voltage could start to droop on the VBAT side, and the voltage would start to droop through the body diode. The charge controller 110 can see the droop by monitoring the current through the VBUS to identify that the current has hit a particular level, and the charge controller 110 can turn on the power device 102 to minimize the voltage drop across the power device 102 (for example, linear regulator and/or MOSFET).

In some embodiments, if a very small voltage drop can be maintained between the VBUS voltage and the VBAT voltage, a high efficiency can be provided. In some embodiments, charger efficiency can be very high (for example, 96-99% at no load, dropping to 90-93% when the system current increases). In some embodiments, even though the efficiency is lowest at high load, actual losses at the charger linear voltage regulator can be low, since the current to the battery is low. This is true, for example, if the total adapter output power is comparable to the battery charge current. However, in some embodiments, if the adapter exhibits a much higher output current, then the charger will show high efficiency for a larger range of system currents.

FIG. 2 illustrates a charger system 200 with a boost voltage regulator. In some embodiments, a mobile system includes a power device 202 (for example, a linear regulator, linear voltage regulator and/or MOSFET device), a battery 204, a system load 206, a connector 208 (for example, a Universal Serial Bus Type-C connector), a charge controller 210 (for example, a battery charge controller), a power delivery (PD) controller 212, a boost voltage regulator (boost VR) 214, a power device 216 and a power device 218. In some embodiments, an adapter 228 and a power delivery (PD) controller 224 are coupled to the mobile system using a connector 226 (for example, a Universal Serial Bus Type-C connector). In some embodiments, adapter 228 can be, for example, a mouse such as a USB mouse, a keyboard such as a USB keyboard, pad drive, etc. or some other device. If the adapter is a device that needs power or needs to power another device, the mobile system can include a boost converter such as, for example, boost voltage regulator 214 to help power and/or charge the adapter device and/or some other device coupled to the adapter.

In some embodiments, power device 202, battery 204, system load 206, connector 208, charge controller 210, power delivery controller 212, power delivery controller 224, and/or connector 226 of FIG. 2 operate the same and/or similarly to power device 102, battery 104, system load 106, connector 108, charge controller 110, power delivery controller 112, power delivery controller 124, and/or connector 126 of FIG. 1, respectively.

In some embodiments, the boost voltage regulator 214 can allow the system (for example, a mobile system) to charge any attached system at a voltage above the battery voltage VBAT. In some embodiments, a boost converter (for example, boost voltage regulator 214) is added between the battery 204 and the USB Type-C connector 208 (and/or USB-C input/output). This can allow the system (for example, a mobile system) to provide a voltage that is well suited to a system which is requested to be charged at a given voltage by the main system. In some embodiments, the boost converter (for example, boost VR 214) is connected to a left side of a power device 218 (for example, a pass field effect transistor or pass FET) that can disconnect the USB-C V_{BUS} voltage from the system.

In some embodiments, a linear regulator charger is used, and the USB-C V_{BUS} voltage is modified to match the battery voltage VBAT. In some embodiments, when the system requirements exceed the adapter 228 power capability, the power device 102 (for example, linear voltage regulator) is completely turned on, and the battery 104 can supplement charging the adapter 228.

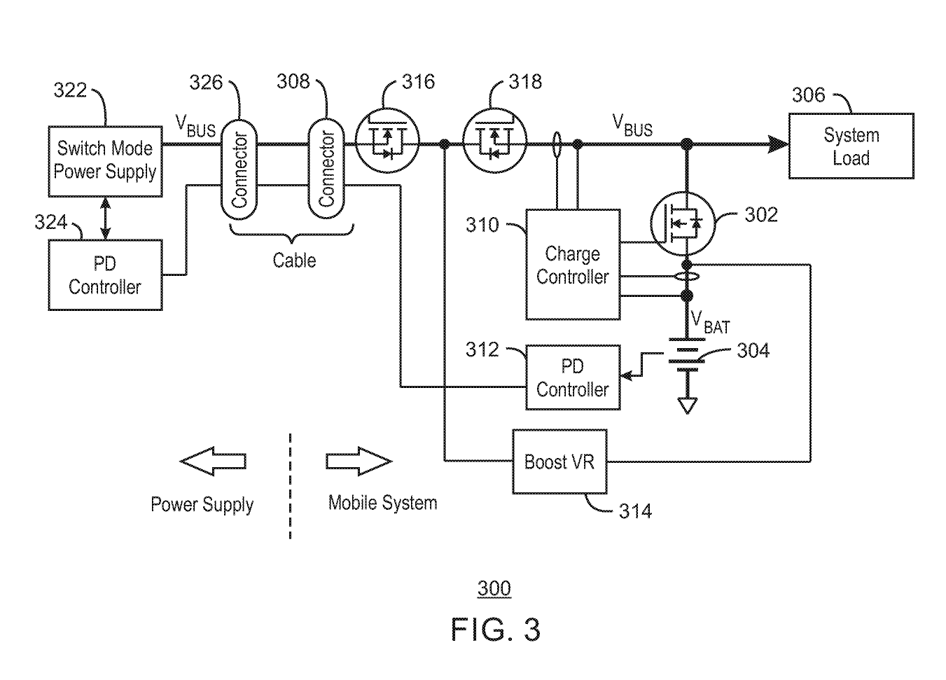

FIG. 3 illustrates a charging system 300 including a mobile system and a power supply. In some embodiments, the mobile system is the same as and/or similar to the mobile system in FIG. 2, but is coupled to a power supply instead of an adapter as in FIG. 2. The mobile system in FIG. 3 includes a power device 302 (for example, a linear regulator, linear voltage regulator and/or MOSFET device), a battery 304, a system load 306, a connector 308 (for example, a Universal Serial Bus Type-C connector), a charge controller 310 (for example, a battery charge controller), a power delivery (PD) controller 312, a boost voltage regulator (boost VR) 314, a power device 316 and a power device 318. The power supply in FIG. 3 can include a switch mode power supply 322, a power delivery (PD) controller 324, and a connector 326 (for example, a Universal Serial Bus Type-C connector). In some embodiments, the charging system 300 can operate the same as and/or similarly to the charging system 100.

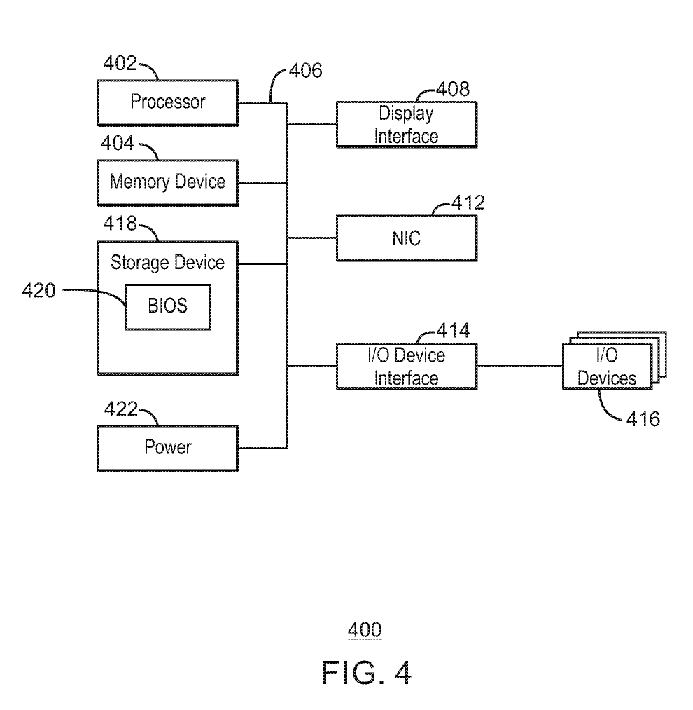

FIG. 4 is a block diagram of an example of a computing device 400 that can include power, power charging, power delivery, power supply and/or power management according to some embodiments. In some embodiments, any portion of the circuits and/or systems illustrated in any one or more of the figures, and any of the embodiments described herein can be included in and/or be implemented by computing device 400. The computing device 400 may be, for example, a mobile phone, mobile device, handset, laptop computer, desktop computer, or tablet computer, among others. The computing device 400 may include a processor 402 that is adapted to execute stored instructions, as well as a memory device 404 (and/or storage device 404) that stores instructions that are executable by the processor 402. The processor 402 can be a single core processor, a multi-core processor, a computing cluster, or any number of other configurations. For example, processor 402 can be an Intel® processor such as an Intel® Celeron, Pentium, Core, Core i3, Core i5, or Core i7 processor. In some embodiments, processor 402 can be an Intel® x86 based processor. In some embodiments, processor 402 can be an ARM based processor. The memory device 404 can be a memory device and/or a storage device, and can include volatile storage, non-volatile storage, random access memory, read only memory, flash memory, or any other suitable memory or storage systems. The instructions that are executed by the processor 402 may also be used to implement power, charging, power supply, power delivery, and/or power management, etc. as described in this specification.

The processor 402 may also be linked through the system interconnect 406 (e.g., PCI®, PCI-Express®, NuBus, etc.) to a display interface 408 adapted to connect the computing device 400 to a display device. The display device (not shown) may include a display screen that is a built-in component of the computing device 400. The display device may also include a computer monitor, television, or projector, among others, that is externally connected to the computing device 400.

In some embodiments, the display interface 408 can include any suitable graphics processing unit, transmitter, port, physical interconnect, and the like. In some examples, the display interface 408 can implement any suitable protocol for transmitting data to the display device. For example, the display interface 408 can transmit data using a high-definition multimedia interface (HDMI) protocol, a DisplayPort protocol, or some other protocol or communication link, and the like

In addition, a network interface controller (also referred to herein as a NIC) 412 may be adapted to connect the computing device 400 through the system interconnect 406 to a network (not depicted). The network (not depicted) may be a cellular network, a radio network, a wide area network (WAN), a local area network (LAN), or the Internet, among others.

The processor 402 may be connected through system interconnect 406 to an input/output (I/O) device interface 414 adapted to connect the computing host device 400 to one or more I/O devices 416. The I/O devices 416 may include, for example, a keyboard and/or a pointing device, where the pointing device may include a touchpad or a touchscreen, among others. The I/O devices 416 may be built-in components of the computing device 400, or may be devices that are externally connected to the computing device 400.

In some embodiments, the processor 402 may also be linked through the system interconnect 406 to a storage device 418 that can include a hard drive, a solid state drive (SSD), a magnetic drive, an optical drive, a USB flash drive, an array of drives, or any other type of storage, including combinations thereof. In some embodiments, the storage device 418 can include any suitable applications. In some embodiments, the storage device 418 can include a basic input/output system (BIOS) 420.

In some embodiments, a power device 422 (for example providing charging, and/or power, and/or power supply, and/or power delivery, and/or power management, and/or power control, for example) is provided. In some embodiments, power 422 can be a part of system 500, and in some embodiments, power 422 can be external to the rest of system 400. In some embodiments, power 422 can provide any of the power and/or charging related techniques described herein. For example, in some embodiments, power 422 can provide power delivery and/or charging as described in reference to and/or illustrated in any of the drawings herein. In some embodiments, for example, power 422 includes one or more elements of FIG. 1, FIG. 2 and/or FIG. 3 such as, for example, power device 102, battery 104, connector 108, charge controller 110, power delivery controller 112, power device 202, battery 204, connector 208, charge controller 210, power delivery controller 212, boost VR 214, power device 216, power device 218, power device 302, battery 304, connector 308, charge controller 310, power delivery controller 312, boost VR 314, power device 316, power device 318, etc.

It is to be understood that the block diagram of FIG. 4 is not intended to indicate that the computing device 400 is to include all of the components shown in FIG. 4. Rather, the computing device 400 can include fewer or additional components not illustrated in FIG. 4 (e.g., additional memory components, embedded controllers, additional modules, additional network interfaces, etc.). Furthermore, any of the functionalities of the power supply 422 may be partially, or entirely, implemented in hardware and/or in the processor 402. For example, the functionality may be implemented with an application specific integrated circuit, logic implemented in an embedded controller, or in logic implemented in the processor 402, among others. In some embodiments, the functionalities of the power supply 422 can be implemented with logic, wherein the logic, as referred to herein, can include any suitable hardware (e.g., a processor, among others), software (e.g., an application, among others), firmware, or any suitable combination of hardware, software, and firmware.

Reference in the specification to “one embodiment” or “an embodiment” or “some embodiments” of the disclosed subject matter means that a particular feature, structure, or characteristic described in connection with the embodiment is included in at least one embodiment of the disclosed subject matter. Thus, the phrase “in one embodiment” or “in some embodiments” may appear in various places throughout the specification, but the phrase may not necessarily refer to the same embodiment or embodiments.

### Example 1

In some examples, a charging system includes a battery and a power device. The power device is to be coupled in series with the battery in a manner that the power device is not in a system load path. The power device is to operate as a linear voltage regulator to control charging power.

### Example 2

In some examples, the charging system of Example 1 is to operate in a hybrid mode when a voltage to be supplied to a system load drops below a voltage of the battery.

### Example 3

In some examples, the charging system of Example 2, where the voltage to be supplied to the system load is a V_{BUS} voltage.

### Example 4

In some examples, the charging system of Example 1 includes a boost voltage regulator coupled between the battery and an input connector.

### Example 5

In some examples, the charging system of Example 1 includes a boost converter to provide a voltage to an adapter coupled to the charging system.

### Example 6

In some examples, the charging system of Example 5, where the boost converter includes a boost voltage regulator.

### Example 7

In some examples, the charging system of Example 1, where the charging system is a Universal Serial Bus charging system.

### Example 8

In some examples, the charging system of Example 1 includes a power delivery controller to adjust a voltage provided to a system load.

### Example 9

In some examples, the charging system of Example 1, where the linear voltage regulator is to regulate a voltage provided to a system load.

### Example 10

In some examples, the charging system of Example 1 includes a power delivery controller to adjust a voltage provided to a system load. The linear voltage regulator is to adjust the voltage provided to the system load more quickly than the power delivery controller.

### Example 11

In some examples, the charging system of Example 1, where the linear voltage regulator comprises a metal oxide semiconductor field effect transistor.

### Example 12

In some examples, the charging system of Example 1, where the linear voltage regulator is to maintain a voltage provided to a system load to be close to a voltage load requirement.

### Example 13

In some examples, the charging system of Example 1, where the linear voltage regulator is to clamp a voltage provided to a system load to a voltage of the battery.

### Example 14

In some examples, the charging system of Example 1, where the charging system is to be coupled to a power supply, both the power supply and the battery to supply voltage to a system load in a hybrid mode.

### Example 15

In some examples, the charging system of Example 1, where the charging system is to be coupled to a power supply. Both the power supply and the battery are to supply voltage to a system load when a voltage supplied to the system load drops below a voltage of the battery.

### Example 16

In some examples, a mobile system including a system load and a charging device. The charging device includes a battery and a power device to be coupled in series with the battery in a manner that the power device is not in a system load path. The power device is to operate as a linear voltage regulator to control charging power.

### Example 17

In some examples, the mobile system of Example 16, where the charging device is to operate in a hybrid mode when a voltage to be supplied to the system load drops below a voltage of the battery.

### Example 18

In some examples, the mobile system of Example 17, where the voltage to be supplied to the system load is a V_{BUS} voltage.

### Example 19

In some examples, the mobile system of Example 16, where the charging device includes a boost voltage regulator coupled between the battery and an input connector.

### Example 20

In some examples, the mobile system of Example 16, where the charging device includes a boost converter to provide a voltage to an adapter coupled to the charging system.

### Example 21

In some examples, the mobile system of Example 16, where the charging device includes a power delivery controller to adjust a voltage provided to the system load.

### Example 22

In some examples, the mobile system of Example 16, where the linear voltage regulator is to regulate a voltage provided to the system load.

### Example 23

In some examples, the mobile system of Example 16, where the charging device includes a power delivery controller to adjust a voltage provided to the system load. The linear voltage regulator is to adjust the voltage provided to the system load more quickly than the power delivery controller.

### Example 24

In some examples, the mobile system of Example 16, where the linear voltage regulator includes a metal oxide semiconductor field effect transistor.

### Example 25

In some examples, the mobile system of Example 16, where the linear voltage regulator is to clamp a voltage provided to the system load to a voltage of the battery.

### Example 26

In some examples, the mobile system of Example 16, where the mobile system is to be coupled to a power supply. Both the power supply and the battery are to supply voltage to the system load in a hybrid mode.

### Example 27

In some examples, the mobile system of Example 16, where the mobile system is to be coupled to a power supply. Both the power supply and the battery are to supply voltage to the system load when a voltage supplied to the system load drops below a voltage of the battery.

### Example 28

In some examples, a charging system includes a battery and a power device to be coupled in series with the battery in a manner that the power device is not in a system load path. The power device is to operate as a linear voltage regulator to control charging power.

### Example 29

In some examples, the charging system of Example 28, where the charging system is to operate in a hybrid mode when a voltage to be supplied to a system load drops below a voltage of the battery.

### Example 30

In some examples, the charging system of Example 28, where the voltage to be supplied to the system load is a V_{BUS} voltage.

### Example 31

In some examples, the charging system of Example 28, including a boost voltage regulator coupled between the battery and an input connector.

### Example 32

In some examples, the charging system of Example 28, including a boost converter to provide a voltage to an adapter coupled to the charging system.

### Example 33

In some examples, the charging system of Example 28, where the boost converter includes a boost voltage regulator.

### Example 34

In some examples, the charging system of Example 28, where the charging system is a Universal Serial Bus charging system.

### Example 35

In some examples, the charging system of Example 28, including a power delivery controller to adjust a voltage provided to a system load.

### Example 36

In some examples, the charging system of Example 28, the linear voltage regulator to regulate a voltage provided to a system load.

### Example 37

In some examples, the charging system of Example 28, including a power delivery controller to adjust a voltage provided to a system load. The linear voltage regulator is to adjust the voltage provided to the system load more quickly than the power delivery controller.

### Example 38

In some examples, the charging system of Example 28, where the linear voltage regulator includes a metal oxide semiconductor field effect transistor.

### Example 39

In some examples, the charging system of Example 28, where the linear voltage regulator is to maintain a voltage provided to a system load to be close to a voltage load requirement.

### Example 40

In some examples, the charging system of Example 28, where the linear voltage regulator is to clamp a voltage provided to a system load to a voltage of the battery.

### Example 41

In some examples, the charging system of Example 28, where the charging system is to be coupled to a power supply. Both the power supply and the battery are to supply voltage to a system load in a hybrid mode.

### Example 42

In some examples, the charging system of any of Examples 28-41, where the charging system is to be coupled to a power supply. Both the power supply and the battery are to supply voltage to a system load when a voltage supplied to the system load drops below a voltage of the battery.

### Example 43

In some examples, a mobile system includes a system load and a charging device. The charging device includes a battery and a power device to be coupled in series with the battery in a manner that the power device is not in a system load path. The power device is to operate as a linear voltage regulator to control charging power.

### Example 44

In some examples, the mobile system of Example 43, where the charging device is to operate in a hybrid mode when a voltage to be supplied to the system load drops below a voltage of the battery.

### Example 46

In some examples, the mobile system of Example 43, where the voltage to be supplied to the system load is a V_{BUS} voltage.

### Example 46

In some examples, the mobile system of Example 43, the charging device including a boost voltage regulator coupled between the battery and an input connector.

### Example 47

In some examples, the mobile system of Example 43, the charging device including a boost converter to provide a voltage to an adapter coupled to the charging system.

### Example 48

In some examples, the mobile system of Example 43, the linear voltage regulator to regulate a voltage provided to the system load.

### Example 49

In some examples, the mobile system of Example 43, where the charging device includes a power delivery controller to adjust a voltage provided to the system load. The linear voltage regulator is to adjust the voltage provided to the system load more quickly than the power delivery controller.

### Example 50

In some examples, the mobile system of Example 43, where the linear voltage regulator includes a metal oxide semiconductor field effect transistor.

### Example 51

In some examples, the mobile system of Example 43, where the linear voltage regulator is to clamp a voltage provided to the system load to a voltage of the battery.

### Example 52

In some examples, the mobile system of any of Examples 43-51, where the mobile system is to be coupled to a power supply. Both the power supply and the battery are to supply voltage to the system load when a voltage supplied to the system load drops below a voltage of the battery.

### Example 53

In some examples, a charging system includes battery means and power device means to be coupled in series with the battery in a manner that the power device means is not in a system load path. The power device means is to operate as linear voltage regulation means to control charging power.

### Example 54

In some examples, the charging system of any of the preceding Examples, including means to operate in a hybrid mode when a voltage to be supplied to a system load drops below a voltage of the battery means.

### Example 55

In some examples, the charging system of Example 54, where the voltage to be supplied to the system load is a V_{BUS} voltage.

### Example 56

In some examples, the charging system of any of the preceding Examples, including boost voltage regulation means coupled between the battery means and input connection means.

### Example 57

In some examples, the charging system of any of the preceding Examples, including boost conversion means to provide a voltage to an adapter coupled to the charging system.

### Example 58

In some examples, the charging system of any of the preceding Examples, where the boost conversion means includes a boost voltage regulation means.

### Example 59

In some examples, the charging system of any of the preceding Examples, where the charging system is a Universal Serial Bus charging system.

### Example 60

In some examples, the charging system of any of the preceding Examples, including power delivery control means to adjust a voltage provided to a system load.

### Example 61

In some examples, the charging system of any of the preceding Examples, the linear voltage regulation means to regulate a voltage provided to a system load.

### Example 62

In some examples, the charging system of any of the preceding Examples, including power delivery control means to adjust a voltage provided to a system load. The linear voltage regulation means is to adjust the voltage provided to the system load more quickly than the power delivery control means.

### Example 63

In some examples, the charging system of any of the preceding Examples, where the linear voltage regulation means includes a metal oxide semiconductor field effect transistor.

### Example 64

In some examples, the charging system of any of the preceding Examples, where the linear voltage regulation means is to maintain a voltage provided to a system load to be close to a voltage load requirement.

### Example 65

In some examples, the charging system of any of the preceding Examples, where the linear voltage regulation means includes means to clamp a voltage provided to a system load to a voltage of the battery means.

### Example 66

In some examples, the charging system of any of the preceding Examples, where the charging system is to be coupled to a power supply. Both the power supply and the battery means are to supply voltage to a system load when a voltage supplied to the system load drops below a voltage of the battery means.

Although example embodiments of the disclosed subject matter are described with reference to circuit diagrams, flow diagrams, block diagrams etc. in the drawings, persons of ordinary skill in the art will readily appreciate that many other ways of implementing the disclosed subject matter may alternatively be used. For example, the arrangements of the elements in the diagrams, and/or the order of execution of the blocks in the diagrams may be changed, and/or some of the circuit elements in circuit diagrams, and blocks in block/flow diagrams described may be changed, eliminated, or combined. Any elements as illustrated and/or described may be changed, eliminated, or combined.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

Various embodiments of the disclosed subject matter may be implemented in hardware, firmware, software, or combination thereof, and may be described by reference to or in conjunction with program code, such as instructions, functions, procedures, data structures, logic, application programs, design representations or formats for simulation, emulation, and fabrication of a design, which when accessed by a machine results in the machine performing tasks, defining abstract data types or low-level hardware contexts, or producing a result.

Program code may represent hardware using a hardware description language or another functional description language which essentially provides a model of how designed hardware is expected to perform. Program code may be assembly or machine language or hardware-definition languages, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Program code may be stored in, for example, one or more volatile and/or non-volatile memory devices, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any tangible mechanism for storing, transmitting, or receiving information in a form readable by a machine, such as antennas, optical fibers, communication interfaces, etc. Program code may be transmitted in the form of packets, serial data, parallel data, etc., and may be used in a compressed or encrypted format.

Program code may be implemented in programs executing on programmable machines such as mobile or stationary computers, personal digital assistants, set top boxes, cellular telephones and pagers, and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter. For example, in each illustrated embodiment and each described embodiment, it is to be understood that the diagrams of the figures and the description herein is not intended to indicate that the illustrated or described devices include all of the components shown in a particular figure or described in reference to a particular figure. In addition, each element may be implemented with logic, wherein the logic, as referred to herein, can include any suitable hardware (e.g., a processor, among others), software (e.g., an application, among others), firmware, or any suitable combination of hardware, software, and firmware, for example.

What is claimed is:

1. A charging system, comprising:
a battery; and
a power device to be coupled in series with the battery in a manner that the power device is not in a system load path, the power device to operate as a linear voltage regulator to control charging power.

2. The charging system of claim 1, wherein the charging system is to operate in a hybrid mode when a voltage to be supplied to a system load drops below a voltage of the battery.

3. The charging system of claim 2, wherein the voltage to be supplied to the system load is a V_{BUS} voltage.

4. The charging system of claim 1, comprising a boost voltage regulator coupled between the battery and an input connector.

5. The charging system of claim 1, comprising a boost converter to provide a voltage to an adapter coupled to the charging system.

6. The charging system of claim 5, wherein the boost converter comprises a boost voltage regulator.

7. The charging system of claim 1, wherein the charging system is a Universal Serial Bus charging system.

8. The charging system of claim 1, comprising a power delivery controller to adjust a voltage provided to a system load.

9. The charging system of claim 1, the linear voltage regulator to regulate a voltage provided to a system load.

10. The charging system of claim 1, comprising a power delivery controller to adjust a voltage provided to a system load, wherein the linear voltage regulator is to adjust the voltage provided to the system load more quickly than the power delivery controller.

11. The charging system of claim 1, wherein the linear voltage regulator comprises a metal oxide semiconductor field effect transistor.

12. The charging system of claim 1, wherein the linear voltage regulator is to maintain a voltage provided to a system load to be close to a voltage load requirement.

13. The charging system of claim 1, wherein the linear voltage regulator is to clamp a voltage provided to a system load to a voltage of the battery.

14. The charging system of claim 1, wherein the charging system is to be coupled to a power supply, both the power supply and the battery to supply voltage to a system load in a hybrid mode.

15. The charging system of claim 1, wherein the charging system is to be coupled to a power supply, both the power supply and the battery to supply voltage to a system load when a voltage supplied to the system load drops below a voltage of the battery.

16. A mobile system, comprising:
a system load; and
a charging device, comprising:
a battery; and
a power device to be coupled in series with the battery in a manner that the power device is not in a system load path, the power device to operate as a linear voltage regulator to control charging power.

17. The mobile system of claim 16, wherein the charging device is to operate in a hybrid mode when a voltage to be supplied to the system load drops below a voltage of the battery.

18. The mobile system of claim 17, wherein the voltage to be supplied to the system load is a V_{BUS} voltage.

19. The mobile system of claim 16, the charging device comprising a boost voltage regulator coupled between the battery and an input connector.

20. The mobile system of claim 16, the charging device comprising a boost converter to provide a voltage to an adapter coupled to the charging system.

21. The mobile system of claim 16, the charging device comprising a power delivery controller to adjust a voltage provided to the system load.

22. The mobile system of claim 16, the linear voltage regulator to regulate a voltage provided to the system load.

23. The mobile system of claim 16, the charging device comprising a power delivery controller to adjust a voltage provided to the system load, wherein the linear voltage regulator is to adjust the voltage provided to the system load more quickly than the power delivery controller.

24. The mobile system of claim 16, wherein the linear voltage regulator comprises a metal oxide semiconductor field effect transistor.

25. The mobile system of claim 16, wherein the linear voltage regulator is to clamp a voltage provided to the system load to a voltage of the battery.

26. The mobile system of claim 16, wherein the mobile system is to be coupled to a power supply, both the power supply and the battery to supply voltage to the system load in a hybrid mode.

27. The mobile system of claim 16, wherein the mobile system is to be coupled to a power supply, both the power supply and the battery to supply voltage to the system load when a voltage supplied to the system load drops below a voltage of the battery.
